(19) United States
(12) Patent Application Publication
(10) Pub. No.: US 2007/0006500 A1
(43) Pub. Date: Jan. 11, 2007

(54) Reflective, permanent, public safety, curb address system

(76) Inventors: Timothy Major, Lakewood, CA (US); Bradford Sorensen, Manhattan Beach, CA (US)

Correspondence Address: BRADFORD SORENSEN, 515 13TH STREET, MANHATTAN BEACH, CA, 90266, US

(21) Appl. No.: 11/169,213

(22) Filed: Jun. 28, 2005

(51) Int. Cl. G09F 7/00

(52) U.S. Cl. 40/612

(57) ABSTRACT

The current invention is a permanent reflective safety curb address that replaces the historic, painted curb address markers with a strong durable, no maintenance, day or night visible legible, evenly spaced, bold, clear, sharp, large font numbers or letters, prismatic lens reflective system, which is permanently printed into the glass or polycarbonate bullet proof address marker with non-toxic, non-fade, non-rub-off, weather resistant, permanent address marker which are protected from vehicle tire contact by a bumper brick overhanging tire rub protector, uses, uses glue that attaches in minutes and lasts for years, provides city logo, county logo, street name and street address, as well in Braille, which provides a greater amount of safety by communicating with fire, police and ambulance reliable address markings instantaneously

### FIELD OF INVENTION

This invention relates to street addresses, specifically the creation of a permanent, reflective, public safety, curb addressing system to replace address numbers currently painted on a street curb

### BACKGROUND

Curb addresses have typically been applied by a stencil and spray paint method of application. This current curb address method is temporary at best. Currently the spray paint application onto the concrete of a curbing can be rubbed off by the tires of the cars parking along the curb. Environmental factors such as ultraviolet light, snow, rain, mud, wind and sand tend to degrade and fade the spray painted image to the point of illegibility within a few short years. When the spray painted addresses become worn or illegible a safety problem arises. Police, medical and fire emergency personnel use the address markings to find a location in an emergency.

### SUMMARY

The present invention provides a solution to the problems and shortcomings presented by spray painted curb addresses. The current invention provides a permanent curb address marking that is legible, high contrast, reflective, durable, strong, colorfast, easy to install, easy to maintain, provides a city identification, provides a street identification, provides a county identification, identifies a real estate tax location, clearly identifies authentic addresses verses privately applied, invalid, or misleading address markers. Some cities require compliance with fire and emergency safety codes regarding clear and accurate address markings to assist emergency personnel in quickly finding a specific address in the shortest amount of time. Places of business are listed in the phone book and elsewhere by street number. These numbers are often impossible to find, as usually there are no mailboxes in a business district. The few numbers which are shown are displayed erratically and are thus not helpful in identifying the place of business. This current invention complies with such needs in an efficient and innovative manner. The current invention provides a protective layer that is polished by, instead of being rubbed off by, a street sweeper brush to result in a no maintenance permanent curb address that is continually polished and cleaned by the very forces that destroy the previous art spray painted curb addresses.

### OBJECTS OF THE INVENTION

The first object of the present invention is to provide a permanent curb address system to replace the temporary spray painted address system now in place.

The second object of the present invention is to provide a curb address system that is legible by utilizing evenly spaced, bold, clear, sharp, large font, numbers or letters which are permanently printed or molded into the permanent address marker.

The third object of the present invention is to provide a curb address system with high contrast for visual clarity. The high contrast is provided by presenting a black or very dark, non reflective number or letter against a reflective white paint or glue background in daylight.

The fourth object of the present invention is to provide a curb address system that is reflective for night and low light situations. The invention provides a prismatic, lens, reflector system

The fifth object of the present invention is to provide a curb address system that utilized a bumper brick over hanging tire rub protector.

The sixth object of the present invention is to provide a curb address system with a durable clear permanent exterior surface like glass or polycarbonate bulletproof glass address protection function.

The seventh object of the present invention is to provide a curb address system with strong permanent glue that attaches the address system to a curb in minutes then lasts for years.

The eighth object of the present invention is to provide a curb address system with a colorfast address marking system for accurate address reading for years.

The ninth object of the present invention is to provide a curb address system easy to install by simply gluing the components to the curb in minutes creating a function that lasts for years.

The tenth object of the present invention is to provide a curb address system that is easy to maintain using existing street cleaning systems. For example, the existing painted curb addresses are rubbed off by street sweeper spinning bristles; the current invention would be cleaned and polished by street sweeper spinning bristles.

The eleventh object of the present invention is to provide a curb address system which provides a city identification logo or lettering.

The twelfth object of the present invention is to provide a curb address system which provides street name identification in addition to the traditional address number.

The thirtieth object of the present invention is to provide a curb address system which provides a county identification for property tax assessment identification.

The fourteenth object of the present invention is to provide a curb address system which clearly identifies authentic addresses verses privately applied, invalid, or misleading painted address markers.

The fifteenth object of the present invention is to provide a protective layer that is polished by, instead of being rubbed off by, a street sweeper brush to result in a no maintenance permanent curb address that is continually polished and cleaned by the very forces that destroy the previous art spray painted curb addresses.
10 current invention curb address.
11 curb face
12 attachment glue
13 protective clear panel
14 glue bumper
15 county logo or lettering
16 city logo or lettering
17 reflective layer
18 address number
19 glue base
20 white reflector
21 black number
22 street surface
23 bumper brick
24 edge glue
25 curb top
26 bumper brick draft angle hole
27 glue filling hole
28 bumper brick top surface
29 bumper brick tire deflection radius
30 bumper brick anti-injury radius
31 bumper brick edge
32 bumper brick top surface edge
33 bumper brick bottom edge
34 rounded bumper
35 typical vehicle tire
36 blind address communication panel
37 typical street sweeper brush

### BRIEF DESCRIPTION OF THE DRAWINGS

FIG. 1 is a perspective view of the street address display system on a typical roadside curb.

FIG. 2 is a perspective view of the street address display system on a typical roadside curb with an additional bumper brick vehicle tire, contact protector

FIG. 3 is a perspective section view of the street address display system on a typical roadside curb with an additional bumper brick vehicle tire, contact protector

FIG. 4 is a side view of the street address display system on a typical roadside curb with an additional bumper brick vehicle tire, contact protector with a typical vehicle tire contacting the bumper

FIG. 5 is a perspective view of the street address display system on a typical roadside curb with a curb top bumper brick

FIG. 6 is a perspective section view of the street address display system on a typical roadside curb with a curb top bumper brick

FIG. 7 is a perspective view of the single layer street address display system on a typical roadside curb

FIGS. is a perspective view of the street address display system utilizing individual number and logo blocks on a typical roadside curb

FIG. 9 is an end view of the street address display system, being cleaned and polished by a typical road sweeper brush

### DESCRIPTION OF THE PREFERRED EMBODIMENT

Referring now to the drawings, wherein like numerals represent like parts throughout, a preferred embodiment of the device of the present invention permanent, reflective, public safety, street address display system, is generally represented by the numeral 10.

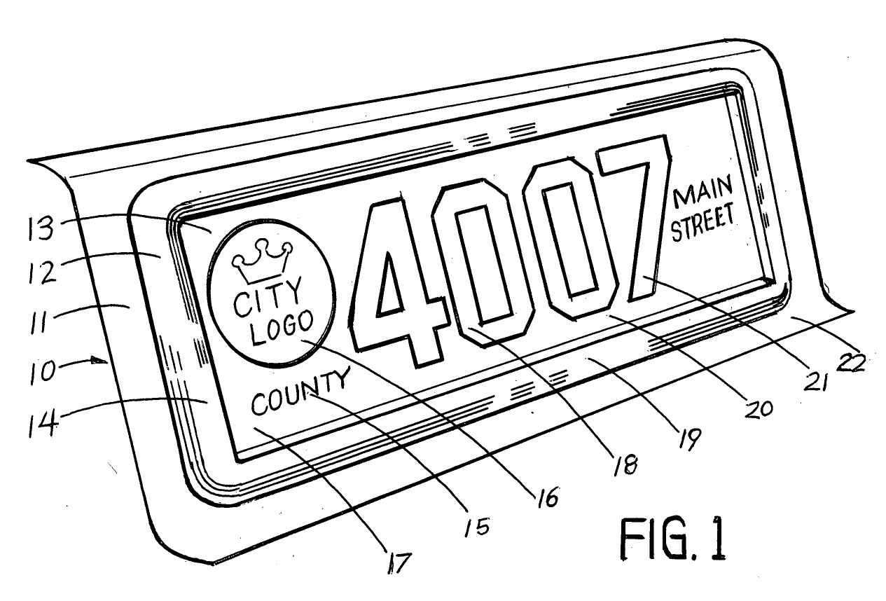

FIG. 1 Illustrates a section through the 10 current invention curb address attached to a typical 11 curb face utilizing strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. Between the 13 protective clear panel and the 12 permanent glue is located a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The 13 protective clear panel has an extra bead of 12 permanent glue covering the bottom edge of the 13 protective clear panel. This extra bead is referred to as the 19 glue base forming a tire protection bumper near the 22 street surface. The 17 reflective layer is comprised of a 20 white reflector with a 21 black number which qualifies under standard building codes as an official curb marker.

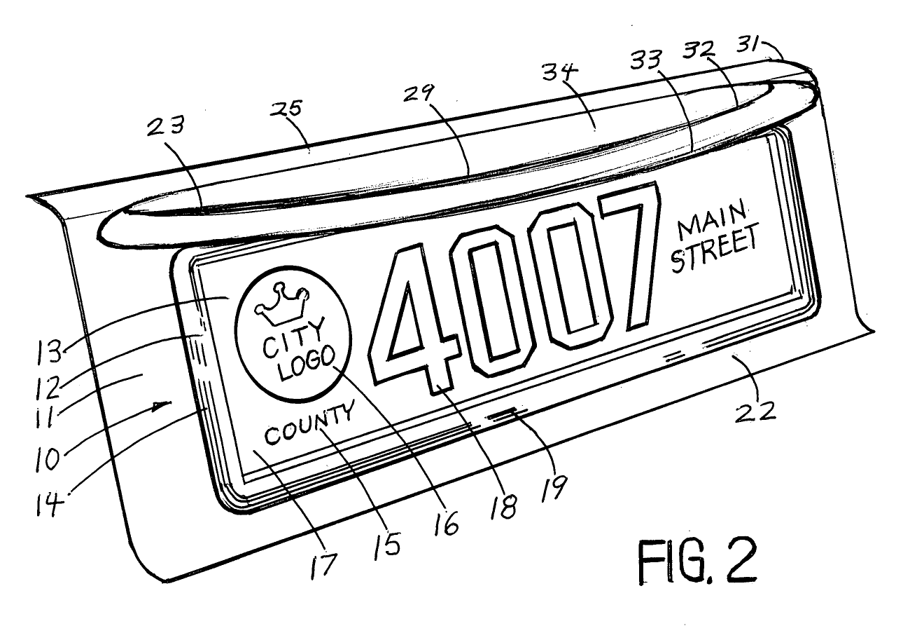

FIG. 2 Illustrates a section through the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. Between the 13 protective clear panel and the 12 permanent glue is located a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The 13 protective clear panel has an extra bead of 12 permanent glue covering the bottom edge of the 13 protective clear panel. This extra bead is referred to as the 19 glue base forming a tire protection bumper near the 22 street surface. In order to protect the 10 current invention curb address from contact with a vehicle tire a 23 bumper brick is adhered to the 25 curb top with the 12 permanent glue which is applied between the 23 bumper brick and the 25 curb top in an amount that overflows to form an 24 edge glue to permanently attach and encase the edges of the 23 bumper brick to the 25 curb top in a permanent fashion. The 23 bumper brick is provided with a 29 bumper brick tire deflection radius which is shaped to deflect the force of the vehicle tires away from the 10 current invention curb address for longevity. The 31 bumper brick edge consists of a 32 bumper brick top surface having a radius that flows into the 33 bumper brick bottom edge forming a 34 rounded bumper which protects the tires, pedestrians, and the 10 current invention curb address from contact.

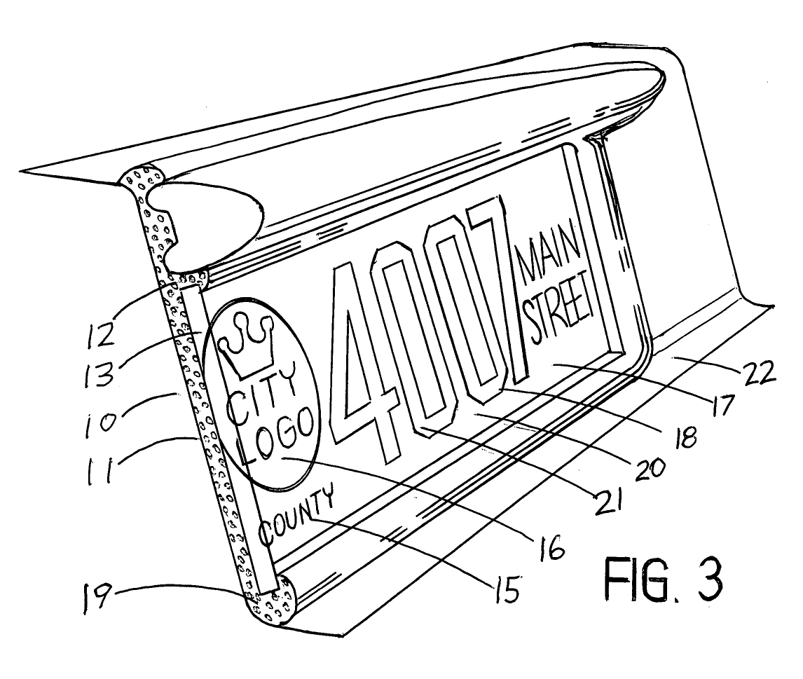

FIG. 3 Illustrates a section through the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. Between the 13 protective clear panel and the 12 permanent glue is located a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The 13 protective clear panel has an extra bead of 12 permanent glue covering the bottom edge of the 13 protective clear panel. This extra bead is referred to as the 19 glue base forming a tire protection bumper near the 22 street surface. The 17 reflective layer is comprised of a 20 white reflector with a 21 black number which qualifies under standard building codes as an official curb marker. In order to protect the 10 current invention curb address from contact with a 35 typical vehicle tire and adhered to the 25 curb top with the 12 permanent glue which is applied between the 23 bumper brick and the 25 curb top in an amount that overflows to form an 24 edge glue to permanently attach and encase the edges of the 23 bumper brick to the 25 curb top in a permanent fashion. In order to increase the strength of the bond between the 23 bumper brick and the 25 curb top multiple 26 bumper brick draft angle holes are provided to become 27 glue filling holes. The 27 glue filling holes are filled with 12 permanent glue up to the 28 bumper brick top surface forming a draft angle enhanced solid permanent connection that provides an excellent foundation for resisting the contacts with 35 vehicle tires over time. The 23 bumper brick is provided with a 29 bumper brick tire deflection radius which is shaped to deflect the force of the 35 typical vehicle tires away from the 10 current invention curb address for longevity. The 23 bumper brick is provided with a 30 bumper brick anti-injury radius that is designed to protect pedestrians from the risk of tripping. The 31 bumper brick edge consists of a 32 bumper brick top surface having a radius that flows into the 33 bumper brick bottom edge forming a 34 rounded bumper which protects the tires, pedestrians, and the 10 current invention curb address from contact.

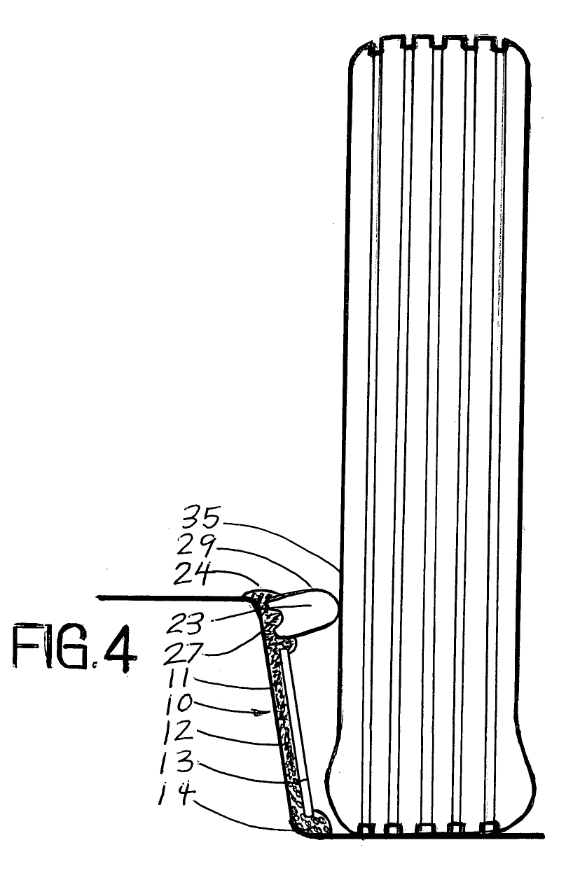

FIG. 4 Illustrates a section through the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. In order to protect the 10 current invention curb address from contact with a 35 typical vehicle tire a 23 bumper brick is adhered to the 11 curb face with the 12 permanent glue which is applied between the 23 bumper brick and the 11 curb face in an amount that overflows to form an 24 edge glue to permanently attach and encase the edges of the 23 bumper brick to the 11 curb face in a permanent fashion. The 27 glue filling holes are filled with 12 permanent glue that provides an excellent foundation for resisting the contacts with 35 vehicle tires over time. The 23 bumper brick is provided with a 29 bumper brick tire deflection radius which is shaped to deflect the force of the 35 typical vehicle tires away from the 10 current invention curb address for longevity.

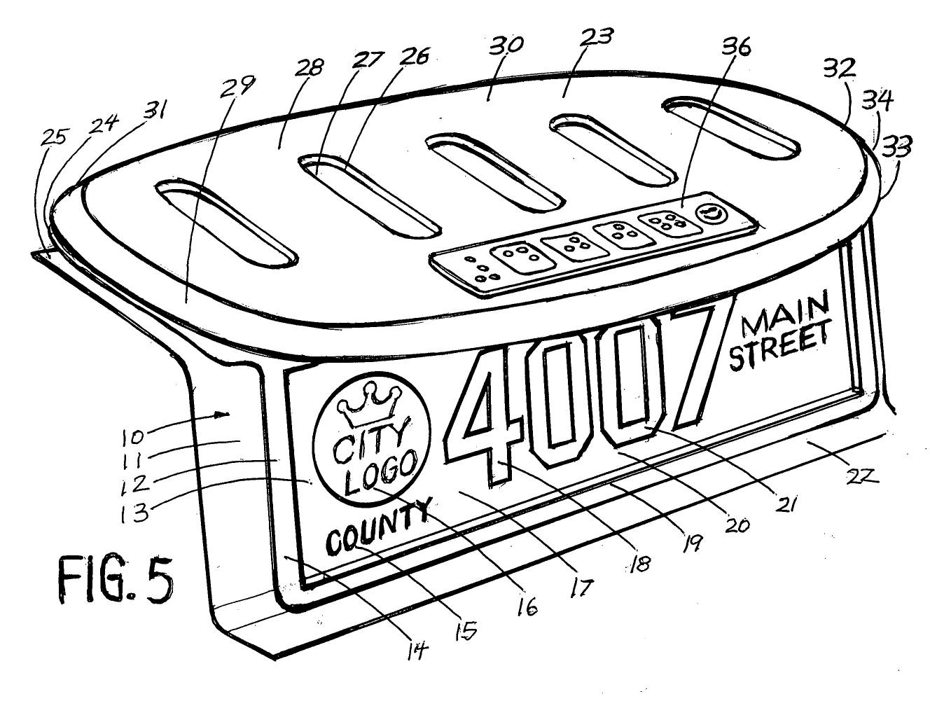

FIG. 5 Illustrates the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. Between the 13 protective clear panel and the 12 permanent glue is located a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The function of the 10 current invention permanent, reflective, public safety, street address display system is to assist fire department personnel in instantaneously finding addresses in emergency situations, to assist police department personnel in quickly locating call addresses, to assist ambulance drivers to arrive at the correct address with speed and accuracy, to assist real estate professionals in finding the authentic city and county of each address, to assist counties in identifying all addresses for tax assessment purposes, and to assist the public to make instant and accurate address identification. The 13 protective clear panel has an extra bead of 12 permanent glue covering the bottom edge of the 13 protective clear panel. This extra bead is referred to as the 19 glue base forming a tire protection bumper near the 22 street surface. The 17 reflective layer is comprised of a 20 white reflector with a 21 black number which qualifies under standard building codes as an official curb marker. The standard building codes specify a six inch tall white background painted on the curb with four inch tall black lettering painted on the white background. The current permanent invention provides an alternative to the practice of using spray paint to create temporary curb addresses. The use of spray paint on a curb places large amounts of aromatic solvents into the air during spraying causing air pollution. The use of spray paint on a curb is eventually entirely rubbed off by tires, weather, street sweepers, and rushing water which leads to a large amount of petrochemical paint solid environmental pollutants to runoff into the environment, causing ocean, lake, and river contamination further causing fish and animal poisoning. The current invention places no pollution into the air or the runoff water. In order to protect the 10 current invention curb address from contact with a 35 typical vehicle tire a 23 bumper brick is adhered to the 25 curb top with the 12 permanent glue which is applied between the 23 bumper brick and the 25 curb top in an amount that overflows to form an 24 edge glue to permanently attach and encase the edges of the 23 bumper brick to the 25 curb top in a permanent fashion. In order to increase the strength of the bond between the 23 bumper brick and the 25 curb top multiple 26 bumper brick draft angle holes are provided to become 27 glue filling holes. The 27 glue filling holes are filled with 12 permanent glue up to the 28 bumper brick top surface forming a draft angle enhanced solid permanent connection that provides an excellent foundation for resisting the contacts with 35 vehicle tires over time. The 23 bumper brick is provided with a 29 bumper brick tire deflection radius which is shaped to deflect the force of the 35 typical vehicle tires away from the 10 current invention curb address for longevity. The 23 bumper brick is provided with a 30 bumper brick anti-injury radius that is designed to protect pedestrians from the risk of tripping. The 31 bumper brick edge consists of a 32 bumper brick top surface having a radius that flows into the 33 bumper brick bottom edge forming a 34 rounded bumper which protects the tires, pedestrians, and the 10 current invention curb address from contact.

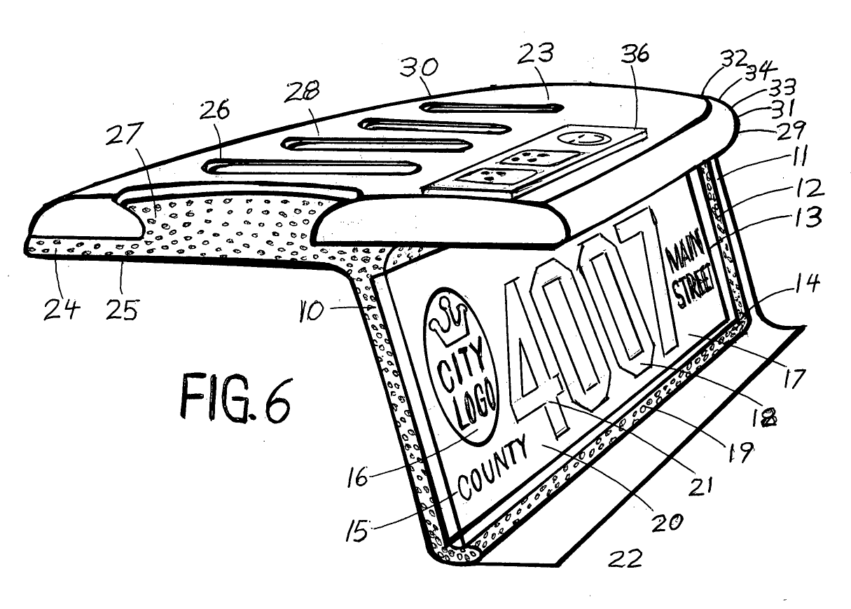

FIG. 6 Illustrates a section through the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. Between the 13 protective clear panel and the 12 permanent glue is located a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The function of the 10 current invention permanent, reflective, public safety, street address display system is to assist fire department personnel in instantaneously finding addresses in emergency situations, to assist police department personnel in quickly locating call addresses, to assist ambulance drivers to arrive at the correct address with speed and accuracy, to assist real estate professionals in finding the authentic city and county of each address, to assist counties in identifying all addresses for tax assessment purposes, and to assist the public to make instant and accurate address identification. The 13 protective clear panel has an extra bead of 12 permanent glue covering the bottom edge of the 13 protective clear panel. This extra bead is referred to as the 19 glue base forming a tire protection bumper near the 22 street surface. The 17 reflective layer is comprised of a 20 white reflector with a 21 black number which qualifies under standard building codes as an official curb marker. The standard building codes specify a six inch tall white background painted on the curb with four inch tall black lettering painted on the white background. The current invention places no pollution into the air or the runoff water. In order to protect the 10 current invention curb address from contact with a 35 typical vehicle tire a 23 bumper brick is adhered to the 25 curb top with the 12 permanent glue which is applied between the 23 bumper brick and the 25 curb top in an amount that overflows to form an 24 edge glue to permanently attach and encase the edges of the 23 bumper brick to the 25 curb top in a permanent fashion. In order to increase the strength of the bond between the 23 bumper brick and the 25 curb top multiple 26 bumper brick draft angle holes are provided to become 27 glue filling holes. The 27 glue filling holes are filled with 12 permanent glue up to the 28 bumper brick top surface forming a draft angle enhanced solid permanent connection that provides an excellent foundation for resisting the contacts with 35 vehicle tires over time. The 23 bumper brick is provided with a 29 bumper brick tire deflection radius which is shaped to deflect the force of the 35 typical vehicle tires away from the 10 current invention curb address for longevity. The 23 bumper brick is provided with a 30 bumper brick anti-injury radius that is designed to protect pedestrians from the risk of tripping. The 31 bumper brick edge consists of a 32 bumper brick top surface having a radius that flows into the 33 bumper brick bottom edge forming a 34 rounded bumper which protects the tires, pedestrians, and the 10 current invention curb address from contact. The 10 current invention curb address may be supplemented by the addition of a 36 blind address communication panel mounted on the top surface of the bumper brick having an embossed Braille or formed address number pressed into the panel to allow a person with visual impairments to feel the symbols.

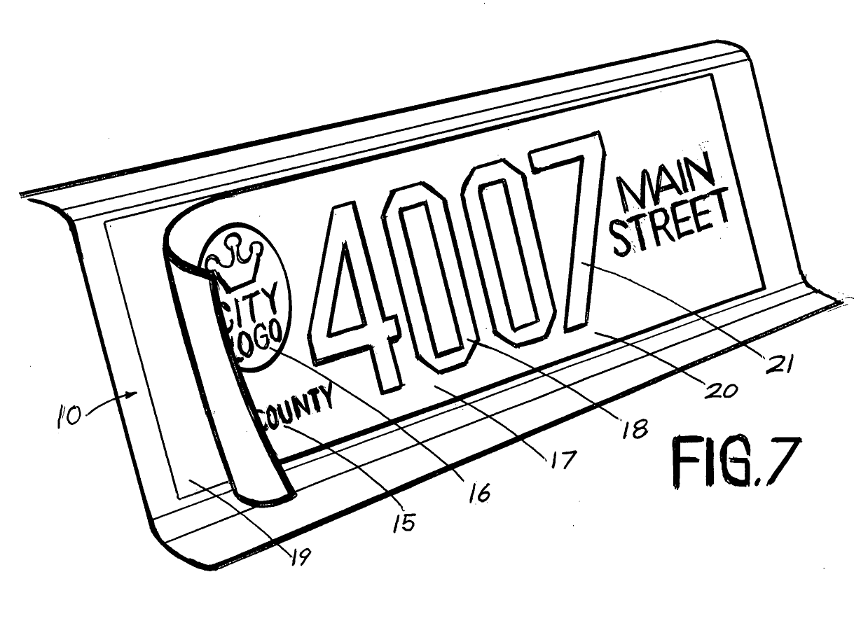

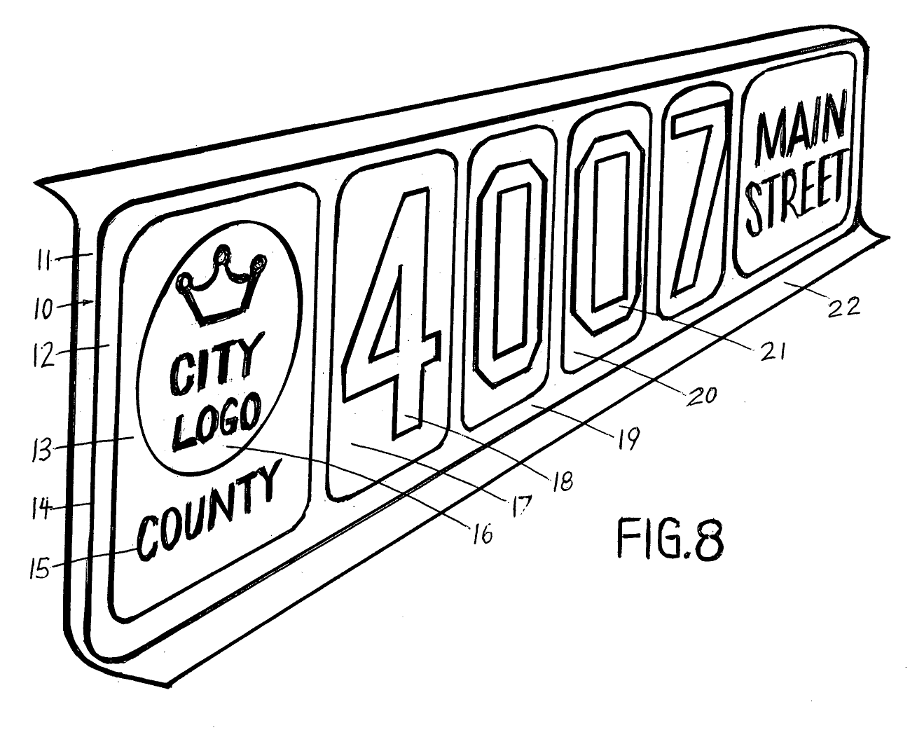

FIG. 7 Illustrates the 10 current invention curb address as a single layer, reflective, printed tape, attached to a typical 11 curb face utilizing a strong, durable, permanent 12 attachment glue that is printed onto the contact surface of the tape and attached the 11 curb face to form a strong bond with the porosity of the concrete. The other side of the tape from the glue side is a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The 17 reflective layer of the tape is comprised of a 20 white reflector with a 21 black number which qualifies under standard building codes as an official curb marker. The standard building codes specify a six inch tall white background painted on the curb with four inch tall black lettering painted on the white background. The current invention places no pollution into the air or the runoff water.

FIG. 8 Illustrates the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. Between the 13 protective clear panel and the 12 permanent glue is located a 17 reflective layer which provides reflection of automotive headlights and other environmental lights for illuminated visual night acuity. The 17 reflective layer is provided with a 15 county logo or lettering, a 16 city logo or lettering, and an 18 address number and street name in order to communicate to any one viewing the display accurate address information. The function of the 10 current invention permanent, reflective, public safety, street address display system is to assist fire department personnel in instantaneously finding addresses in emergency situations, to assist police department personnel in quickly locating call addresses, to assist ambulance drivers to arrive at the correct address with speed and accuracy, to assist real estate professionals in finding the authentic city and county of each address, to assist counties in identifying all addresses for tax assessment purposes, and to assist the public to make instant and accurate address identification. The 13 protective clear panel has an extra bead of 12 permanent glue covering the bottom edge of the 13 protective clear panel. This extra bead is referred to as the 19 glue base forming a tire protection bumper near the 22 street surface. The 17 reflective layer is comprised of a 20 white reflector with a 21 black number which qualifies under standard building codes as an official curb marker. The standard building codes specify a six inch tall white background painted on the curb with four inch tall black lettering painted on the white background. The current permanent invention provides an alternative to the practice of using spray paint to create temporary curb addresses. The use of spray paint on a curb places large amounts of aromatic solvents into the air during spraying causing air pollution. The use of spray paint on a curb is eventually entirely rubbed off by tires, weather, street sweepers, and rushing water which leads to a large amount of petrochemical paint solid environmental pollutants to runoff into the environment, causing ocean, lake, and river contamination further causing fish and animal poisoning. The current invention places no pollution into the air or the runoff water.

Thus, although there have been described particular embodiments of the present invention of a new and useful street address display, it is not intended that such references be construed as limitations upon the scope of this invention except as set forth in the following claims. Further, although there have been described certain dimensions used in the preferred embodiment, it is not intended that such dimensions be construed as limitations upon the scope of this invention except as set forth in the following claims.

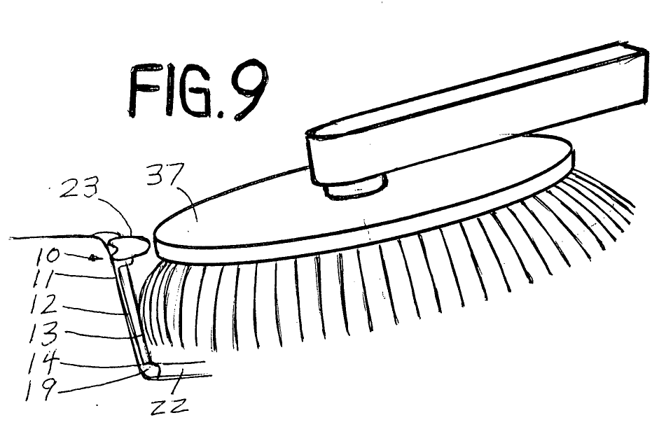

FIG. 9 Illustrates the 10 current invention curb address attached to a typical 11 curb face utilizing a strong, durable, permanent 12 attachment glue that is painted onto the concrete of the 11 curb face in order to form a strong bond with the porosity of the concrete. The 13 protective clear panel is a strong, durable, permanent sheet of material such as, glass, tempered glass, polycarbonate bullet-proof glass, acrylic, or other strong, clear, permanent material. The 12 permanent glue is also painted onto the rear face of the 13 protective clear panel in order to provide excellent glue adhesion to both the 11 curb face and 13 protective clear panel which are joined together, forming a glue-to-glue bond between the curb and the panel. After the 13 protective clear panel is adhered to the 11 curb face an extra bead of the 12 permanent glue is applied to the edges of the 13 clear panel to form a 14 glue bumper that provides edge protection from contact with typical vehicle tires. This extra bead is referred to as the 19 glue base forming a tire protection bumper near the 22 street surface. The 37 street sweeper brush rotates against the 13 protective layer, providing a cleaning and polishing action in stead of rubbing off the previous spray painted curb lettering. The 23 bumper brick is located at the top of the 10 permanent curb address and is out of the way of the 37 street sweeping bristles as they polish the 10 permanent curb address automatically.

1. A permanent, reflective, public safety, curb addressing system including a reflective layer which is printed with address, street, city, county, state or country information attached to the inside of a clear, protective layer made of glass, polycarbonate, acrylic or other clear, permanent, protective material, attached to a roadside curb utilizing a strong, durable, permanent glue in order to effectively communicate address information in a day or night situation.

2. A permanent, reflective, public safety, curb addressing system of claim 1 including a weather resistant seal around the perimeter of the protective layer to permanently protect the system from water damage.

3. A permanent, reflective, public safety, curb addressing system of claim 1 including non-toxic materials that do not require spraying toxic paint into the air or allowing portions of the curb address to be rubbed off, flaked off, or washed off into the run off water, there by protecting health and the environment and prohibiting air, land and water pollution.

4. A permanent, reflective, public safety, curb addressing system of claim 1 including a bumper brick that has the function of protecting the permanent curb address from tire contact related to the parking of vehicles along the curb.

5. A permanent, reflective, public safety, curb addressing system of claim 1 including the engraved address information of the street, city, county, state or country written in Braille to allow the visually impaired to find their way around the city.

6. A permanent, reflective, public safety, curb addressing system of claim 1 including a protective layer that is polished by, instead of being rubbed off by, a street sweeper brush to result in a no maintenance permanent curb address that is continually polished and cleaned by the very forces that destroy the previous art painted curb addresses.

7. A permanent, reflective, public safety, curb addressing system of claim 1 including either a prismatic reflective lens or a glass bead reflective lens that returns the beams of a car's headlights back at the driver of the car.

8. A permanent, reflective, public safety, curb addressing system including a single layer, reflective tape, printed with address, street, city, county, state or country information attached to a curb, utilizing a strong, durable, permanent attachment glue that is applied onto the contact surface of the tape and attached to the curb face to form a strong bond with the porosity of the concrete curb.
